(19) United States
(12) Patent Application Publication
(10) Pub. No.: US 2023/0122604 A1
(43) Pub. Date: Apr. 20, 2023

(54) JOINED BODY

(71) Applicant: KABUSHIKI KAISHA TOKAI RIKA DENKI SEISAKUSHO, Aichi (JP)

(72) Inventors: Yusuke TAGUCHI, Aichi (JP); Masataka MIZUNO, Aichi (JP)

(73) Assignee: KABUSHIKI KAISHA TOKAI RIKA DENKI SEISAKUSHO, Aichi (JP)

(21) Appl. No.: 17/966,109

(22) Filed: Oct. 14, 2022

(30) Foreign Application Priority Data
Oct. 20, 2021 (JP) 2021-171721

(51) Int. Cl. F16B 5/00

(52) U.S. Cl. CPC F16B 5/0096

(57) ABSTRACT

To reduce concern of separation due to a user's unintended application of a load.

A joined body of a first structure member having a frame-like structure and a second structure member joined to an inside of the first structure member, wherein the first structure member has a protruding portion in which an anchor shape is formed, the second structure member has a hole portion that comes into contact with the protruding portion of the first structure member, and the protruding portion has a stress concentration portion on which stress concentrates when a load is applied to the second structure member.

### CROSS REFERENCE TO RELATED APPLICATION(S)

This application is based upon and claims benefit of priority from Japanese Patent Application No. 2021-171721, filed on Oct. 20, 2021, the entire contents of which are incorporated herein by reference.

### BACKGROUND

The present invention relates to a joined body.

In recent years, joined bodies that separate during an overload have been developed. For example, Patent Document 1 discloses an emergency button switch cover structure that separates from a switch case by elastic deformation of a joint of the switch cover when an overload is applied to the switch cover.
[Patent Document 1] Japanese Patent No. 4368047

### SUMMARY

In such a switch cover structure, a structure that separates due to an overload and does not easily separate is preferable.

Consequently, the present invention was contrived in view of the above problem, and an object of the present invention is to provide a novel and improved joined body that makes it possible to reduce concern of separation due to a user's unintended application of a load.

To solve the above problem, a certain aspect of the present invention provides a joined body of a first structure member having a frame-like structure and a second structure member joined to an inside of the first structure member, wherein the first structure member has a protruding portion in which an anchor shape is formed, the second structure member has a hole portion that comes into contact with the protruding portion of the first structure member, and the protruding portion has a stress concentration portion on which stress concentrates when a load is applied to the second structure member.

According to the present invention described above, it is possible to reduce concern of separation due to a user's unintended application of a load.

### BRIEF DESCRIPTION OF THE DRAWINGS

FIG. 1 is a diagram illustrating an example of an external configuration of a switch case according to the present embodiment.

FIG. 2 is a diagram illustrating an example of an external configuration related to the back of the switch case according to the present embodiment.

FIG. 3 is a rear view of the switch case according to the present embodiment.

FIG. 4 is a diagram illustrating a cross section of a frame along line A-A shown in FIG. 3.

FIG. 5 is a diagram illustrating a cross section of a panel along line A-A shown in FIG. 3.

FIG. 6 is a diagram illustrating a cross section of the switch case along line A-A shown in FIG. 3.

FIG. 7 is a diagram illustrating another example of a cross section of the switch case along line A-A shown in FIG. 3.

### DETAILED DESCRIPTION OF THE EMBODIMENT(S)

Hereinafter, preferred embodiments of the present invention will be described in detail with reference to the accompanying drawings. It should be noted that, in this specification and the accompanying drawings, structural elements that have substantially the same function and structure are denoted with the same reference numerals, and repeated explanation thereof is omitted.

### 1. Embodiment

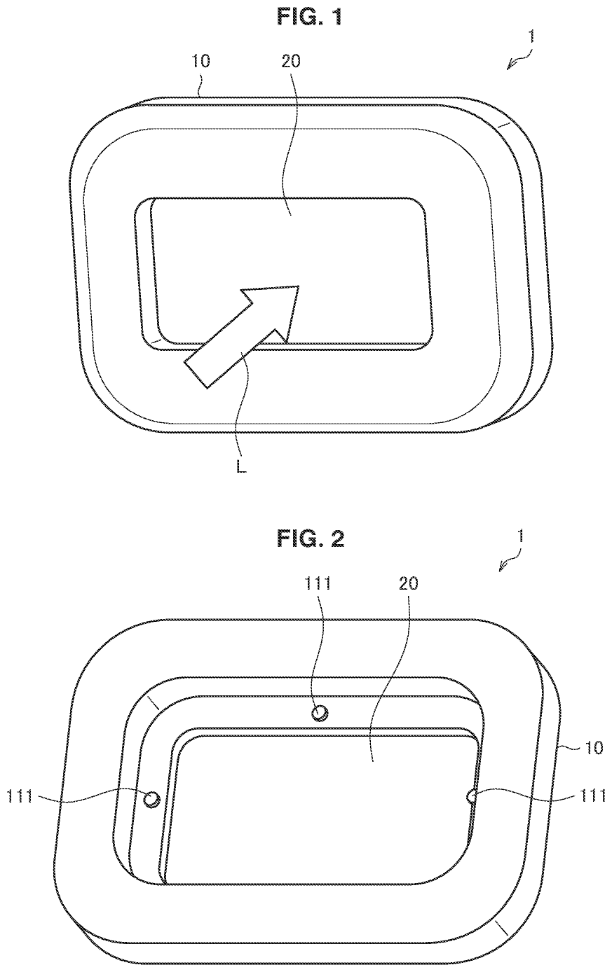

FIG. 1 is a diagram illustrating an example of an external configuration of a switch case 1 according to the present embodiment.

The switch case 1 according to the present embodiment is an example of a joined body in which a frame 10 and a panel 20 are joined together as shown in FIG. 1. The switch case 1 is, for example, a case that protects a switch.

In addition, the switch case 1 according to the present embodiment may be mounted on a vehicle which is an example of a moving object. The switch case 1 may be, for example, a case that protects a switch provided in a vehicle for reporting in an emergency. Meanwhile, the moving object according to the present embodiment is not limited to a vehicle. For example, the moving object according to the present embodiment may be a ship, an airplane, or the like.

The frame 10 according to the present embodiment is an example of a first structure member. The frame 10 has a frame-like structure. In addition, the frame 10 supports the panel 20 by the panel 20 to be described later being joined to the inside of the frame 10.

The panel 20 according to the present embodiment is an example of a second structure member. The panel 20 is joined to the inside of the frame 10.

In addition, the panel 20 prevents a user from unintentionally pressing a switch installed on the back of the panel 20.

In addition, the panel 20 may have text or a drawing associated with the switch installed the back of the panel 20 printed on the surface of the panel 20.

The switch case 1 according to the present embodiment has, for example, a structure in which the panel 20 is separated from the frame 10 by a load L equal to or greater than a predetermined value being applied to the panel 20 by a user in the vehicle.

The user can press the switch located on the back of the panel 20 shown in FIG. 1 through the separated panel 20. A specific structure related to the separation of the frame 10 and the panel 20 will be described later.

In the following description, the surface of the switch case 1 shown in FIG. 1 may be called a front surface, and a surface opposite to the front surface may be called a back surface.

FIG. 2 is a diagram illustrating an example of an external configuration related to the back surface of the switch case 1 according to the present embodiment.

The frame 10 according to the present embodiment has protruding portions in which an anchor shape 111 as shown in FIG. 2 is formed.

The anchor shape 111 according to the present embodiment may be, for example, a shape for suppressing the separation of the frame 10 and the panel 20. For example, the anchor shape 111 may be a shape in which the panel 20 can be clamped as shown in FIG. 2. A specific structure of the anchor shape 111 will be described later.

In addition, the frame 10 and the panel 20 that constitute the switch case 1 may be joined together through, for example, two-color molding. For example, the frame 10 is molded in a first molding process, and the panel 20 is molded over the frame 10 in a second molding process.

Alternatively, the panel 20 may be molded in the first molding process, and the frame 10 may be molded over the panel 20 in the second molding process.

In addition, the frame 10 and the panel 20 are made of, for example, a resin material. In addition, the frame 10 and the panel 20 may be molded using different resin materials through two-color molding.

For example, the frame 10 may be molded from a resin such as acrylonitrile butadiene styrene (ABS), polycarbonate (PC), polybutylene terephthalate (PBT), polypropylene (PP), or nylon 66.

Further, the panel 20 may be molded over the frame 10 from a resin such as a thermoplastic polyurethane elastomer (TPU), thermoplastic vulcanizate (TPV), a thermoplastic elastomer (TPE), liquid silicone rubber (LSR), or a thermoplastic polyester elastomer (TPC). Meanwhile, the resin materials used for the frame 10 and the panel 20 described above may be reversed.

In addition, the resin material for molding the frame 10 and the panel 20 is not limited to the above-described example. However, it is preferable that the frame 10 and the panel 20 be molded from a resin material having high bonding properties. In addition, it is preferable that the frame 10 and the panel 20 be molded from a resin material having physical and chemical compatibility.

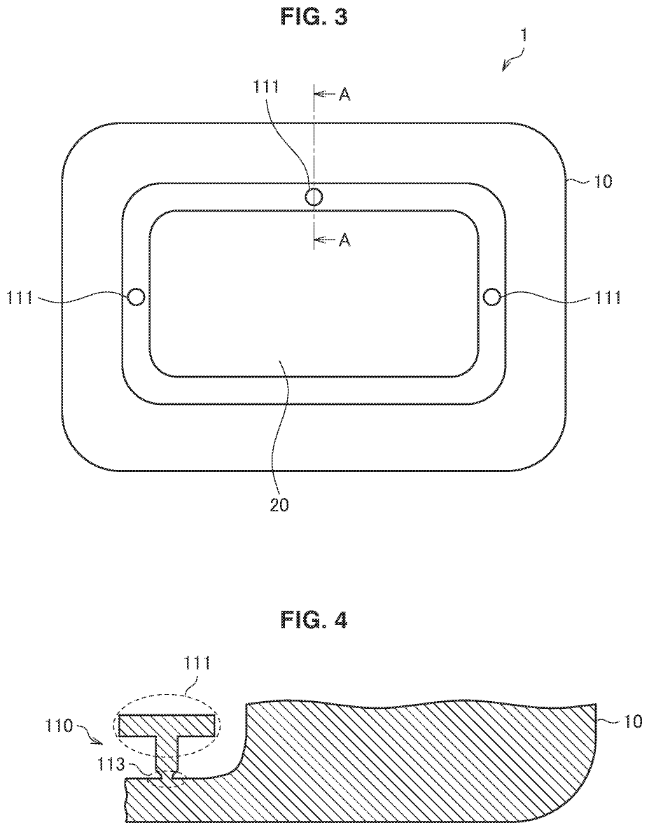

FIG. 3 is a rear view of the switch case 1 according to the present embodiment. The frame 10 and the panel 20 according to the present embodiment are joined together at three points in the anchor shape 111, for example, as shown in FIG. 3.

However, the number of joints of the frame 10 and the panel 20 according to the present embodiment in the anchor shape 111 is not limited to three. For example, the number of joints in the anchor shape 111 according to the present embodiment may be one, two, or four or more.

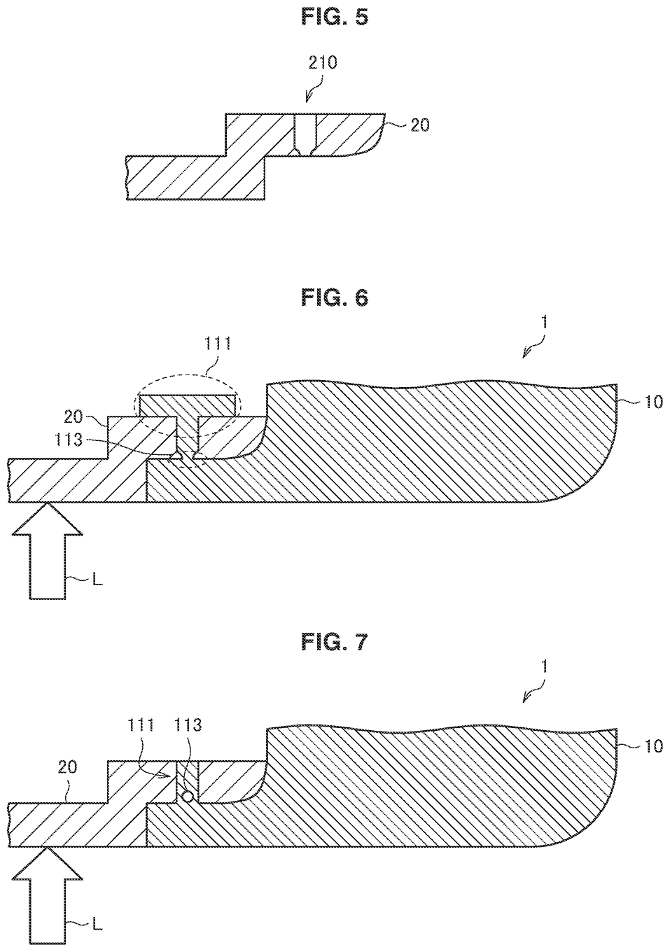

Hereinafter, referring to FIGS. 4 and 5, cross sections of the frame 10 and the panel 20 according to the present embodiment along line A-A will be described in the order of the respective cross-sectional views.

### (Cross-Sectional View of the Frame 10)

FIG. 4 is a diagram illustrating a cross section of the frame 10 along line A-A shown in FIG. 3.

The anchor shape 111 according to the present embodiment is a shape for suppressing the separation of the frame 10 and the panel 20. For example, as shown in FIG. 4, the anchor shape 111 may be a tip portion formed at the tip of a protruding portion 110 having a diameter larger than the diameter of a hole portion 210 of the panel 20 to be described later.

Meanwhile, the anchor shape 111 according to the present embodiment is not limited to a cylindrical shape. For example, the anchor shape 111 may be prismatic or hemispherical.

In addition, the protruding portion 110 has a stress concentration portion 113 on which stress concentrates when a load is applied to the panel 20 shown in FIG. 1. The stress concentration portion 113 according to the present embodiment may be, for example, a notch as shown in FIG. 4.

Meanwhile, the shape and size of the notch according to the present embodiment are not limited to the example shown in FIG. 4. The shape and size of the notch may be appropriately changed in accordance with the diameter of the protruding portion 110 and the load required to separate the frame 10 and the panel 20.

### (Cross-Sectional View of the Panel 20)

FIG. 5 is a diagram illustrating a cross section of the panel 20 along line A-A shown in FIG. 3. As shown in FIG. 5, the panel 20 has the hole portion 210 that comes into contact with the protruding portion 110 provided in the frame 10. For example, the hole portion 210 is formed by enclosing the protruding portion 110 of the frame 10 through two-color molding.

Meanwhile, in a case where the protruding portion 110 and the hole portion 210 are formed at a plurality of locations (for example, three locations), the shapes and sizes of the protruding portion 110 and the hole portion 210 may be the same as each other at all locations, or may be different from each other at the locations.

The cross sections of the frame 10 and the panel 20 according to the present embodiment along line A-A shown in FIG. 3 have been described above. Next, a cross section of the switch case 1 according to the present embodiment along line A-A shown in FIG. 3 will be described with reference to FIG. 6.

### (Cross Section of Switch Case 1)

FIG. 6 is a diagram illustrating a cross section of the switch case 1 along line A-A shown in FIG. 3. FIG. 6 is an example of the switch case 1 in which the frame 10 and the panel 20 are joined together through the two-color molding described above.

For example, when a user presses a switch installed on the back of the switch case 1, the user applies the load L to the surface of the panel 20 in a vertical upward direction shown in FIG. 6.

When the load L is applied, the separation of the frame 10 and the panel 20 is suppressed by thermal fusion bonding between the frame 10 and the panel 20.

Further, the anchor shape 111 of the frame 10 prevents the panel 20 from moving in a vertical upward direction, and thus the separation of the frame 10 and the panel 20 is suppressed.

In this way, a structure in which the separation of the frame 10 and the panel 20 is suppressed makes it possible to prevent the frame 10 and the panel 20 from being separated from each other in the case of a user's unintended erroneous operation.

In addition, when the load L is applied, stress concentrates on the stress concentration portion 113. For example, in a case where a notch that breaks when the load L is equal to or greater than a predetermined value is formed in the protruding portion 110 as the stress concentration portion 113, the stress concentration portion 113 is broken by a user applying a load equal to or greater than the predetermined value, and thus the frame 10 and the panel 20 can be separated from each other.

More specifically, in a case where a notch that breaks at 60 N is formed in the protruding portion 110 as the stress concentration portion 113, the stress concentration portion 113 is broken by a user applying a load L equal to or greater than 60 N, and thus the frame 10 and the panel 20 can be separated from each other. Meanwhile, 60 N is an example of the load L which is intentionally applied by a user when the user presses a switch, and can be appropriately changed in accordance with, for example, the type or application of the switch, the sex or age of the user, and the like.

Thereby, the switch case 1 according to the present embodiment can have a structure in which the frame 10 and the panel 20 are separated from each other only when the panel 20 is intentionally pressed by the user and the frame 10 and the panel 20 are not separated from each other in the case of the user's unintended application of the load L.

In addition, a load with which the frame 10 and the panel 20 are separated from each other can be adjusted by changing the shape and size of the notch. Thereby, the switch case 1 according to the present embodiment can further improve the user's convenience.

Meanwhile, the anchor shape 111 and the shape of the stress concentration portion 113 according to the present embodiment are not limited to the example shown in FIG. 4. Next, a modification example of the cross section along line A-A will be described with reference to FIG. 7.

### Modification Example

FIG. 7 is a diagram illustrating a modification example of the cross section of the switch case 1 along line A-A shown in FIG. 3.

The anchor shape 111 according to the present embodiment may be, for example, unevenness formed around the protruding portion 110. In this case, the separation of the frame 10 and the panel 20 can be suppressed by the anchoring effect of the unevenness formed around the protruding portion 110 and the surface of the hole portion 210 of the panel 20.

In addition, the stress concentration portion 113 according to the present embodiment may be, for example, a through hole for the trunk portion of the protruding portion 110 as shown in FIG. 7. For example, a user can break the protruding portion 110 with the through hole as a starting point by applying the load L equal to or greater than a predetermined value.

In addition, as with the above-described notch, the size and shape of the through hole may be appropriately changed in accordance with a load required to separate the frame 10 and the panel 20.

In addition, a method of manufacturing the switch case 1 shown in FIG. 7 is not limited to two-color molding. For example, the frame 10 and the panel 20 according to the modification example may be individually manufactured using any manufacturing method.

For example, the frame 10 and the panel 20 may be joined together through a fitting process such as interference fitting. Thereby, restrictions on manufacturing the switch case 1 can be further reduced.

In addition, the material of the switch case 1 according to the modification example shown in FIG. 7 is not limited to a resin material. The material of the frame 10 and the panel 20 according to the modification example may be, for example, a metal material.

Heretofore, according to the switch case 1 of the present embodiment described above, only when a user intentionally applies a load to the panel 20, the stress concentration portion 113 can be broken, and the panel 20 can be prevented from falling off in the case of the user's unintended erroneous operation.

### 2. Supplement

Heretofore, preferred embodiments of the present invention have been described in detail with reference to the accompanying drawings, but the present invention is not limited thereto. It should be understood by those skilled in the art that various changes and alterations may be made without departing from the spirit and scope of the appended claims, and that these changes and alterations also naturally fall within the technical scope of the present invention.

In addition, the effects described in the present specification are merely illustrative or exemplary and not restrictive. That is, the technique according to the present disclosure can exhibit other effects which are obvious to those skilled in the art from the description of this specification, in addition to or instead of the above effects.

For example, although an example in which the frame 10 has the protruding portion 110 and the panel 20 has the hole portion 210 has been described in this specification, for example, the frame 10 may have the hole portion and the panel 20 may have the protruding portion.

What is claimed is:

1. A joined body of a first structure member having a frame-like structure and a second structure member joined to an inside of the first structure member,
wherein the first structure member has a protruding portion in which an anchor shape is formed,
the second structure member has a hole portion that comes into contact with the protruding portion of the first structure member, and
the protruding portion has a stress concentration portion on which stress concentrates when a load is applied to the second structure member.

2. The joined body according to claim 1, wherein the anchor shape is a shape for suppressing separation of the first structure member and the second structure member.

3. The joined body according to claim 2, wherein the anchor shape includes a tip portion formed at a tip of the protruding portion having a diameter larger than a diameter of the hole portion.

4. The joined body according to claim 3, wherein the first structure member is formed and then joined through two-color molding in which the second structure member is formed over the first structure member.

5. The joined body according to claim 2, wherein the anchor shape includes unevenness formed around the protruding portion that comes into contact with the hole portion.

6. The joined body according to claim 1, wherein the stress concentration portion includes a notch formed in the protruding portion.

7. The joined body according to claim 6, wherein the notch is broken by applying a load equal to or greater than a predetermined value.

8. The joined body according to claim 7, wherein the predetermined value includes 60 N.

9. The joined body according to claim 1, wherein the first structure member and the second structure member are made of a resin material.

10. The joined body according to claim 1, wherein the joined body is mounted on a moving object.

11. The joined body according to claim 10, wherein the joined body includes a switch case that protects a switch mounted on the moving object.
